(19) United States
(12) Patent Application Publication
(10) Pub. No.: US 2025/0383002 A1
(43) Pub. Date: Dec. 18, 2025

(54) SPRING END CAP WITH RETENTION FINGERS

(71) Applicant: Schaeffler Technologies AG & Co. KG, Herzogenaurach (DE)

(72) Inventors: David Avins, Burbank, OH (US); Scott Strong, Perrysville, OH (US)

(73) Assignee: Schaeffler Technologies AG & Co. KG, Herzogenaurach (DE)

(21) Appl. No.: 18/740,761

(22) Filed: Jun. 12, 2024

(51) Int. Cl. F16F 1/00

(52) U.S. Cl. CPC F16F 1/00; F16F 2230/0029; F16F 2238/026

(57) ABSTRACT

A spring end cap includes a base and a plurality of fingers. The base extends annularly about an axis and includes a planar side extending orthogonal to the axis. The plurality of fingers extend from the planar side and are spaced from each other about the axis. In some example embodiments, each finger extends axially away from the planar side. In an example embodiment, each finger includes an end spaced from the planar side. In an example embodiment, each finger includes a first outer surface and a second outer surface. The first outer surface is disposed between the second outer surface and the planar side and is arranged radially inside of the second outer surface. In an example embodiment, the spring end cap also includes a plurality of undercut portions each circumferentially aligned with one respective finger. Each undercut portion extends from the planar side to the one respective finger.

### TECHNICAL FIELD

The present disclosure generally relates to a spring assembly including a coil spring and a spring end cap, and more specifically to a spring end cap including a plurality of fingers configured to retain the spring end cap on the coil spring.

### BACKGROUND

Some spring assemblies include coil springs that have interrupted surfaces in locations that contact components configured to activate the coil spring. Endcaps are assembled to the coil spring to better support the interrupted surfaces on the locations that contact the components configured to activate the coil spring. However, assembling the end caps to the coil spring can introduce stress into the coil spring, which can adversely impact the durability and service life of the coil spring. It is desirable to have alternative designs and configurations to reduce stress on the coil spring caused by the end cap.

### SUMMARY

Example embodiments broadly comprise a spring end cap including a base and a plurality of fingers. The base extends annularly about an axis and includes a planar side extending orthogonal to the axis. The plurality of fingers extend from the planar side and are spaced from each other about the axis. In some example embodiments, each finger extends axially away from the planar side. In an example embodiment, each finger includes an end spaced from the planar side. In an example embodiment, each finger includes a first outer surface and a second outer surface. The first outer surface is disposed between the second outer surface and the planar side and is arranged radially inside of the second outer surface. In an example embodiment, the spring end cap also includes a plurality of undercut portions each circumferentially aligned with one respective finger. Each undercut portion extends from the planar side to the one respective finger.

Other example aspects broadly comprise a spring assembly including a coil spring having a longitudinal end and an end cap engaged with the longitudinal end of the coil spring. The end cap includes a base extending annularly about an axis and a plurality of fingers. The base includes a planar side in contact with the longitudinal end and the plurality of fingers extend from the planar side and are received in the coil spring. The plurality of fingers are spaced from each other about the axis. In an example embodiment, each finger extends axially away from the planar side. In an example embodiment, the coil spring includes a dead coil and an active coil. The dead coil is in contact with each of the fingers and the active coil is spaced from each of the fingers. In an example embodiment, each finger includes an end spaced from the planar side.

In some example embodiments, each finger includes a first outer surface and a second outer surface. The first outer surface is disposed between the second outer surface and the planar side, and is arranged radially inside of the second outer surface. In an example embodiment, in an uninstalled state, a diameter of the second outer surface is greater than a diameter of a radial inner surface of the coil spring. In an example embodiment, the fingers are configured to deflect radially inwardly during installation of the end cap to the coil spring. In an example embodiment, the planar side extends radially outside of the longitudinal end of the coil spring. In an example embodiment, the end cap also includes a plurality of undercut portions each circumferentially aligned with one respective finger. Each undercut portion extends from the planar side to the one respective finger.

Embodiments presented herein provide the advantageous benefit of providing an end cap having a plurality of fingers configured to engage a coil spring, which can deflect during assembly of the end cap to the coil spring. Further, embodiments disclosed herein offer design advantages by reducing deflection in the coil spring during installation of the end cap to the coil spring, which can reduce residual stress in the coil spring. Thus, the durability and the service life of the coil spring is increased, contributing to an increase in the durability and service life of the spring assembly.

### BRIEF DESCRIPTION OF THE DRAWINGS

FIG. 1 illustrates a perspective view of an exemplary spring end cap according to the present disclosure; and

FIG. 2 illustrates a cross-sectional view of a spring assembly including the spring end cap of FIG. 1;

FIG. 3 illustrates an enlarged view of an area of the spring assembly shown in FIG. 2;

FIG. 4 illustrates a perspective view of another exemplary spring end cap according to the present disclosure.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

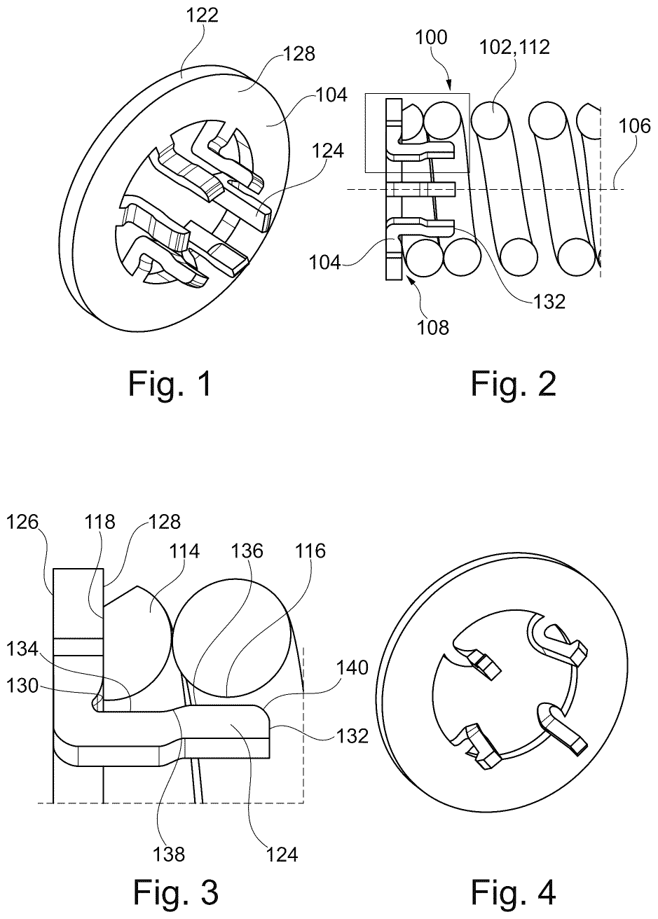

Referring to FIGS. 1-3, a spring assembly 100 includes: a coil spring 102; and end cap 104. The coil spring 102 includes: a helical axis 106 (also known as a longitudinal axis or a coil axis); a first longitudinal end 108; and a second longitudinal end (not shown) spaced from the first longitudinal end 108 along the helical axis 106. The first longitudinal end 108 includes a first planar surface 118, and the second longitudinal end includes a second planar surface (not shown). The first planar surface 118 and the second planar surface face away from each other relative to the helical axis 106. The planar surfaces may be orthogonal to the helical axis 106. The coil spring 102 may be a straight spring, as shown in the Figures. As another example, the coil spring 102 may be arcuately shaped.

The coil spring 102 further includes active coil 112, dead coils 114 at end 108, and a radially inner surface 116 formed by the turns 112, 114. The turns 112, 114 and the radial inner surface 116 surround helical axis 106, and the helical axis 106 is centered with respect to the turns 112, 114 and the radial inner surface 116. Thus, the radial inner surface 116 faces the helical axis 106. By active coil, we mean a coil that is subjected to compression and expansion. By dead coil, we mean that adjacent spring coils rest upon one another such that there is no compression in that part of the spring. Words such as “axial,” “radial,” “circumferential,” “outward,” etc. as used herein are intended to be with respect to the helical axis 106, unless specified otherwise.

The spring assembly 100 may further include an outer coil spring (not shown). The outer coil spring may be arranged concentrically with the coil spring 102. The outer coil spring may extend about the coil spring 102 relative to the helical axis 106. That is, the coil spring 102 may be nested within the outer coil spring. The outer coil spring may further include two longitudinal ends spaced from each other and each having respective planar surfaces. Each planar surface of the outer coil spring may be axially aligned with the corresponding planer surface of the coil spring 102. That is, each planar surface of the outer coil spring may be co-planar with the corresponding planar surface of the coil spring 102.

The first end cap 104 is engaged with the first longitudinal end 108. A second end cap may be engaged with the second longitudinal end. The first end cap 104 and the second end cap may be substantially identical to each other. That is, a size and/or shape of the end caps may be within manufacturing tolerances of each other.

The end cap is a stamped part. That is, the end cap may be formed by stamping and then machined for desired finished surfaces. In this way, the end cap reduces cost and complexity associated with typical forged end caps.

End cap 104 includes a base 122 and a plurality of fingers 124 extending from the base 122. The base 122 extends annularly about the helical axis 106. The base 122 includes a first planar side 126 and a second planar side 128 each extending orthogonal to the helical axis 106. The planar sides 126, 128 face in opposite axial directions from each other relative to the helical axis 106. The second planar side 128 is arranged axially between the first planar side 126 and the coil spring 102. Specifically, the second planar side 128 is arranged to contact the planar surface 118 on the coil spring 102. The second planar side 128 may be co-planar with the planar surface 118 on the coil spring 102. The base 122 may extend radially outside of the coil spring 102. In such an example, the second planar side 128 may be arranged to further contact the corresponding planar surface on the outer coil spring.

The second planar side 128 may include a plurality of undercut portions 130. Each undercut portion 130 may be arranged circumferentially at each finger 124. Each undercut portion 130 may include a conical surface (not numbered) extending from the second planar side 128 towards the first planar side 126. Each undercut portion 130 may further include a planar surface (not numbered) extending parallel to the second planar side 128 and extending from the conical surface. Each undercut portion 130 may further include a partial toroidal surface (not numbered) connecting the planar surface with the corresponding finger 124.

The fingers 124 are configured to retain the end cap 104, 106 on the coil spring 102, e.g., via an interference fit. The fingers 124 are spaced, e.g., uniformly or non-uniformly, from each other circumferentially about the helical axis 106. The spring assembly 100 may include any suitable number of fingers 124. The fingers 124 extend from the second planar side 128 of the base 122.

In one example, the fingers 124 extend axially along the helical axis 106, i.e., away from the first planar side 126. In such an example, each finger 124 includes an end 132 spaced from the second planar side 128. The end 132 may be spaced from the second planar side 128 by any suitable amount. For example, the end 132 may arranged radially between the helical axis 106 and the dead coil 114. The end 132 may extend co-planar with the second planar side 128.

Each finger 124 further includes a first outer surface 134; a second outer surface 136; and a conical surface 138 extending from the first outer surface 134 to the second outer surface 136. The first outer surface 134 is arranged between the second planar side and the second outer surface 136. For example, the first outer surface 134 may extend from the undercut portion, e.g., the partial toroidal surface thereof. The second outer surface 136 extends from the conical surface 138. The second outer surface 136 is arranged radially outside of the first outer surface 134. Axial lengths of the outer surfaces 134, 136 are selected based on wire diameter and a number of dead coils.

Each finger 124 may further include a transition surface 140 extending from the second outer surface 136 to the end 132. The transition surface 140 may have a conical shape, i.e., taper from the second outer surface 136 to the end 132. As another example, the transition surface 140 may have a rounded shape from the second outer surface 136 to the end 132.

In an uninstalled state, a diameter of the second outer surface 136 is larger than a diameter of the inner radial surface 116 of the dead coil 114. During installation of the end cap 104 to the coil spring 102, the fingers 124, e.g., the transition portion 140, engage the dead coil 114, e.g., the radial inner surface 116 thereof, which causes the fingers 124 to deflect radially inward, i.e., towards the helical axis 106. Since the fingers 124 deflect during installation, deflection of the dead coil 114 is reduced, which in turn reduces residual stress in the deal coil 114. The end cap 104 is then pressed onto the coil spring 102 until the planar side 128 contacts the planar surface 118. In an installed state, the second outer surface 136 has an interference fit with the radial inner surface 116 of the dead coil 114. The outer radial expansion of the fingers 124 resulting from the need to deflect radially inwardly during installation retains the end cap 104 on the coil spring 102. The end cap 104 is, e.g., radially and/or axially, spaced from active coils 112 in the assembled state.

Providing an end cap having a plurality of fingers configured to deflect radially inward during installation to a coil spring reduces deflection in the coil spring during installation of the end cap to the coil spring, which can reduce residual stress in the coil spring. Thus, the durability and the service life of the coil spring is increased, contributing to an increase in the durability and service life of the spring assembly.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### REFERENCE NUMERALS

100 Spring assembly
102 Coil spring
104 End cap
106 Helical axis
108 Longitudinal end (spring, first)
112 Active coil, turn
114 Deal coil, turn
116 Radially inner surface
118 Planar surface (longitudinal end, first)
122 Base (end cap)
124 Fingers (end cap)
126 Planar side (first)
128 Planar side (second)
130 Undercut portions (second planar side)
132 End (finger)
134 Outer surface (finger, first)
136 Outer surface (finger, second)
138 Conical surface (finger)
140 Transition surface (finger)

What is claimed is:

1. A spring end cap, comprising:
a base extending annularly about an axis, the base including a planar side extending orthogonal to the axis; and
a plurality of fingers extending from the planar side, the plurality of fingers being spaced from each other about the axis.

2. The spring end cap of claim 1, wherein each finger extends axially away from the planar side.

3. The spring end cap of claim 2, wherein each finger includes an end spaced from the planar side.

4. The spring end cap of claim 1, wherein each finger includes a first outer surface and a second outer surface, the first outer surface being disposed between the second outer surface and the planar side and being arranged radially inside of the second outer surface.

5. The spring end cap of claim 1, further comprising a plurality of undercut portions each circumferentially aligned with one respective finger, each undercut portion extends from the planar side to the one respective finger.

6. A spring assembly, comprising:
a coil spring having a longitudinal end; and
an end cap engaged with the longitudinal end of the coil spring, the end cap including:
a base extending annularly about an axis, the base including a planar side in contact with the longitudinal end; and
a plurality of fingers extending from the planar side and received in the coil spring, the plurality of fingers being spaced from each other about the axis.

7. The spring assembly of claim 6, wherein each finger extends axially away from the planar side.

8. The spring assembly of claim 6, wherein the coil spring includes a dead coil and an active coil, the dead coil being in contact with each of the fingers and the active coil being spaced from each of the fingers.

9. The spring assembly of claim 6, wherein each finger includes an end spaced from the planar side.

10. The spring assembly of claim 6, wherein each finger includes a first outer surface and a second outer surface, the first outer surface being disposed between the second outer surface and the planar side and being arranged radially inside of the second outer surface.

11. The spring assembly of claim 10, wherein, in an uninstalled state, a diameter of the second outer surface is greater than a diameter of a radial inner surface of the coil spring.

12. The spring assembly of claim 6, wherein the fingers are configured to deflect radially inwardly during installation of the end cap to the coil spring.

13. The spring assembly of claim 6, wherein the planar side extends radially outside of the longitudinal end of the coil spring.

14. The spring assembly of claim 6, wherein the end cap further includes a plurality of undercut portions each circumferentially aligned with one respective finger, each undercut portion extends from the planar side to the one respective finger.
